(19) United States
(12) Patent Application Publication
(10) Pub. No.: US 2025/0146268 A1
(43) Pub. Date: May 8, 2025

(54) MODULAR PANEL SYSTEM FOR STRUCTURES

(71) Applicant: MULTY HOME LP, Concord (CA)

(72) Inventors: Dwight BUCKLE, Guelph (CA); Mark PAPENFUSS, Kitchener (CA); Alden EVANGELISTA, Kleinburg (CA); Derek ERDMAN, Toronto (CA)

(21) Appl. No.: 18/942,023

(22) Filed: Nov. 8, 2024

Related U.S. Application Data
(60) Provisional application No. 63/547,817, filed on Nov. 8, 2023.
(60) Provisional application No. 63/600,736, filed on Nov. 20, 2023.

(51) Int. Cl. E04B 1/343; A01G 9/28; B65D 88/00

(52) U.S. Cl. CPC E04B 1/34321; A01G 9/28; B65D 88/005

(57) ABSTRACT

A modular panel system that can be readily assembled and configured into several types of structures that may be used both indoors and outdoors.

### CROSS-REFERENCE TO RELATED APPLICATIONS

This application claims the priority of U.S. Provisional Application Ser. No. 63/547,817 filed on Nov. 8, 2023, and to U.S. Provisional Application Ser. No. 63/600,736 filed on Nov. 20, 2023, the entire contents of which are incorporated herein by reference.

This application claims the priority of U.S. Provisional Application Ser. No. 63/547,817 filed on Nov. 8, 2023, and to U.S. Provisional Application Ser. No. 63/600,736 filed on Nov. 20, 2023, the entire contents of which are incorporated herein by reference.

### FIELD OF THE INVENTION

The present invention relates to a modular panel system that can be readily configured into several different types of structures that may be used both indoors and outdoors. The modular structures can be disassembled and transformed into dispartate movable structures. Also described are kits for making the modular transformable structures.

### BACKGROUND OF THE INVENTION

The backyard is often modernized into an extension of the indoor living area. As such, backyards are often designed to create a stylish and comfortable environment. Storage, privacy and entertainment are desired features to make the backyard a more useful living area. To this end, planters/garden beds, sheds, tables, bars and the like are common features used in backyards. These are typically prefabricated or preassembled in an unchangeable configuration and size and suitable only for a sole purpose. They may be difficult to move and store. They typically require assembly using fasteners for individual components that can be lost or damaged. Over time, as the function of the backyard changes, new items must be purchased and old ones discarded.

There is a need for a modular panel system that is versatile and ecofriendly and helps to solve at least one or more of the aforementioned disadvantages.

### SUMMARY OF THE INVENTION

Herein described is a modular panel system comprising structural components that can be assembled without separate fasteners/tools into a variety of different types of structures of varying use and size. The structures can be quickly and easily assembled, disassembled and reassembled into different structures and/or sizes as desired.

Furthermore, the versatility of the modular panel system enables assembly of modular structures that can be disassembled and transformed into a new modular structure(s) as desired. Alternatively, any assembled structure can be disassembled and stored and is also readily transportable. The modular system described herein does not require separate fastening means such for example screws nor tools for assembly. The modular system described herein saves time, materials, capital, and labor and results in modular structures with a pleasing design esthetic.

According to an aspect of the invention is a modular panel system comprising modular structural components that can be assembled, disassembled, and/or reassembled into a variety of different modular structures of varying sizes and uses. The modular structures are suitable for outdoor and/or indoor use. For example some structures may include but are not limited to: planters; raised garden beds; storage sheds for example for clothes, tools, pool equipment, gardening equipment, toys, garbage bins, recycling bins; storage containers; salt storage boxes; deck boxes; composter; garbage bin; bars; bar carts; storage chests; tables; vegetable boxes; shelving; closet storage/organization system; armoire/hutch; playhouse; garage cabinet and wall system; shoes/boots shelf/cabinet; tables; panel deck flooring system; gazebo; outdoor kitchen cabinetry; and container hose reels.

The modular panel system is very versatile comprising structural components that can be assembled to make a desired structure configured to a certain size. Once assembled, the structure can be readily disassembled to add or remove components to vary the size with respect to height and/or width. Furthermore, a structure can be disassembled and reassembled to make a dispartate structure, for example a raised garden bed can be disassembled and transformed to make for example a storage shed or a table.

Components of the modular panel system are configured for assembly and disassembly without requiring separate fasteners or tools. Disassembled modular structural components are easy to transport and store.

According to an aspect of the invention is a modular panel system comprising modular structural components comprising:
one or more of: wall panel, corner post, middle post, post cap, post foot, post connector, base tray and optional decorative elements/accessories, said modular structural components reversibly connectable to form a modular structure. The modular structural components described herein are configured to fit naturally and securely together requiring no extra components, parts/fasteners or tools but instead use a high efficiency reversible fit. The fit assembly is highly stable due to the deep configuration/engagement providing superior stability and safety.

In aspects, the modular structural components are each of integral structure. In other words, each component can be integrally formed. Modular structural components of the modular panel system described herein can be fabricated from compositions comprising thermoplastic polymers, resins, elastomers, plastics, recycled plastics (composites), recycled crumb rubber and any mixtures thereof. Any suitable plastics material and composites can be used. Any suitable molding technique (and combinations thereof) can be used as understood by one of skill in the art to make the components such as for example injection molding, extrusion molding, compression molding, and the like.

According to a further aspect is a kit comprising: at least one wall panel, at least one corner post, at least one middle post, at least one post cap, at least one post foot, at least one post connector, at least one base tray, optional decorative element(s), optional accessories(s), optional cable(s); and optional instructions for assembly.

According to an aspect of the invention is a modular wall panel adapted for reversible connection with corresponding modular structure component(s), the modular wall panel having a vertical axis and a horizontal axis, the wall panel being substantially square shaped.

According to an aspect of the invention is a modular wall panel comprising:
a top, a bottom, a left side, a right side, a front and a back,
wherein the left side and the right side are configured with connection means for engaging with a post, and
wherein the bottom is configured with flexible clip portions for engaging with a base tray or to the top of a second modular wall panel.

In aspects, the wall panel comprises an integral body, the body comprising a top, a bottom, a left side, and a right side, wherein the left side and the right side comprise integrally formed first connection means for reversibly securing to a corresponding post; wherein the bottom comprises an integrally formed second connection means for reversibly securing to a top of a second wall panel and/or to a base tray. In aspects, the wall panel is of unitary construction. In aspects, the first connection means comprise two different connection formats. In aspects, one of the connection formats is to prevent vertical movement of the wall panel when affixed to a post, and the other of the connection formats is for increased horizontal stability of connection with the post.

The modular panel system described herein comprises modular structural components that are fabricated customizable to any color, can be blended with UV-12 inhibitors to protect color, can be decorated with a desired logo, icon, or finish, are weather resistant, substantially maintenance free, easy to clean as needed, structurally strong, easy to move, substantially non-porous and non-hydroscopic, and impervious to water damage, rust and insects.

The modular structural components of the modular panel system can be fabricated of varying sizes (e.g. length, height, width).

In aspects, components of the modular panel system can be injected molded.

A modular structure comprising:
at least one wall panel,
at least one corner post,
at least one middle post,
optional post cap,
optional post foot,
optional post connector, and
optional base tray,
wherein the at least one wall panel comprises an integral body, the body comprising a first connection means at each side for reversibly securing to the at least corner post and/or to the at least one corresponding post, and a second connection means located at the bottom for reversibly securing to a top of a second wall panel or the optional base tray. In aspects, the wall panel is of unitary construction.

In aspects the modular structure is to be formed is not limited. The structural components described herein are configured to fit naturally together requiring no extra components or parts/fasteners or tools but instead use a combination of high efficiency stable connection means.

The features, functions, and advantages that have been discussed can be achieved independently in various embodiments of the present disclosure or may be combined in yet other embodiments. Other features, functions and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon illustrating the principles of the present disclosure. Moreover, in the drawings, like reference numerals designate corresponding parts throughout the several views;

FIG. 1A is a perspective partial exploded view showing the modular structural components of a non-limiting embodiment of the modular panel system of the invention, as a modular raised planter bed in accordance with the invention;

FIG. 1B is a perspective view of the modular planter bed of FIG. 1A assembled;

FIG. 1C is a top plan view of the assembled modular planter bed;

FIG. 2A is a perspective partial exploded view showing the modular structural components of a non-limiting embodiment of the modular panel system of the invention, as a two level modular raised planter bed in accordance with the invention;

FIG. 2B is a perspective view of the two level modular planter bed of FIG. 2A assembled;

FIG. 2C is a front elevational view of the assembled two level modular planter bed of FIG. 2B;

FIG. 2D is a side elevational view of the assembled two level modular planter bed of FIG. 2B, the other side being substantially identical thereto;

FIG. 2E is a top plan view of the assembled two level modular planter bed of FIG. 2B;

FIG. 2F is a bottom plan view of the assembled two level modular planter bed of FIG. 2B;

FIG. 2G is a front elevational view of FIG. 2C, containing sectional lines A-A;

FIG. 2H is a back elevational view of FIG. 2G taken along sectional lines A-A of FIG. 2G;

FIG. 2I is an enlarged sectional view taken of the circle shown in FIG. 2H;

FIG. 3A is a front perspective view of a modular wall panel in accordance with the invention;

FIG. 3B is a back perspective view of the modular wall panel of FIG. 3A;

FIG. 3C is a front elevational view of the modular wall panel of FIG. 3A;

FIG. 3D is a back elevational view of the modular wall panel of FIG. 3A;

FIG. 3E is a top plan view of the modular wall panel of FIG. 3A;

FIG. 3F is a bottom plan view of the modular wall panel of FIG. 3A;

FIG. 3G is a side plan view of the modular wall panel of FIG. 3A, the other side being substantially identical thereto;

FIG. 3H is a perspective enlarged view showing the bottom of a modular wall panel engaged with the top of a second modular wall panel;

FIG. 4A is a perspective view of a modular corner post in accordance with the invention;

FIG. 4B is a side view of the modular corner post of FIG. 4A showing the two types of connection means;

FIG. 4C is a top plan view of the modular corner post of FIG. 4A;

FIG. 5A is a perspective view of a modular middle post, in accordance with the invention;

FIG. 5B is a front elevational view of a modular middle post of FIG. 5A;

FIG. 5C is a side elevational view of the modular middle post of FIG. 5A, the other side being substantially identical thereto;

FIG. 5D is a top plan view of the modular middle post of FIG. 5A;

FIG. 6A is a perspective view of a modular post connector, in accordance with the invention;

FIG. 6B is a side elevational view of the modular post connector of FIG. 6A, the other side being substantially identical thereto;

FIG. 6C is a front elevational view of the modular post connector of FIG. 6A;

FIG. 6D is a top plan view of the modular post connector of FIG. 6A;

FIG. 7A is a perspective view of a modular base tray in accordance with the invention;

FIG. 7B is a top plan view of the modular base tray of FIG. 7A;

FIG. 7C is a bottom plan view of the modular base tray of FIG. 7A;

FIG. 7D is a side elevational view of the modular base tray of FIG. 7A;

FIG. 8A is a perspective view of a further embodiment of the modular panel system of the invention, configured as an open bottom square modular structure;

FIG. 8B is a top plan view of the square modular structure of FIG. 8A;

FIG. 9 is a perspective view of a further embodiment of the modular panel system of the invention configured as a patio storage table with a door within the face of the modular wall panel;

FIG. 10A is a perspective view of a further embodiment of the modular panel system of the invention, configured as a storage cabinet with a shelf and rod system; and

FIG. 10B is an enlarged view of the circled portion of FIG. 10A, showing the shelf and rod system enlarged.

### DESCRIPTION OF THE INVENTION

All publications, patent applications, patents, and other references mentioned herein are incorporated by reference in their entirety. The publications and applications discussed herein are provided solely for their disclosure prior to the filing date of the present application. Nothing herein is to be construed as an admission that the present invention is not entitled to antedate such publication by virtue of prior invention. In addition, the materials, methods, and examples are illustrative only and are not intended to be limiting.

Unless defined otherwise, all technical terms used herein have the same meaning as commonly understood by one of ordinary skill in the art to which the invention pertains. Although any methods and materials similar or equivalent to those described herein can be used in the practice for testing of the present invention, the typical materials and methods are described herein.

It is also to be understood that the terminology used herein is for the purpose of describing particular aspects only, and is not intended to be limiting.

The articles “a” and “an” are used herein to refer to one or to more than one (i.e., to at least one) of the grammatical object of the article. By way of example, “an element” means one element or more than one element.

As used herein, the terms “invention” or “present invention” are non-limiting terms and not intended to refer to any single aspect of the particular invention but encompass all possible aspects as described in the specification and the claims.

As used herein the terms ‘comprises’, ‘comprising’, ‘includes’, ‘including’, ‘having’ and their inflections and conjugates denote ‘including but not limited to’ and are to be understood to be open-ended, e.g., to mean including but not limited to.

As used herein, the term “about” refers to variation in the numerical quantity. In the broadest aspect, the term “about” means within 10% of the reported numerical value. In another aspect, the term “about” means within 5% of the reported numerical value. Yet, in another aspect, the term “about” means within 10, 9, 8, 7, 6, 5, 4, 3, 2, or 1% of the reported numerical value.

Should a range of values be recited, it is merely for convenience or brevity and includes all the possible sub-ranges as well as individual numerical values within and about the boundary of that range. Any numeric value, unless otherwise specified, includes also practical close values and integral values do not exclude fractional values. Sub-range values and practically close values should be considered as specifically disclosed values.

It will be understood that any component defined herein as being included may be explicitly excluded from the claimed invention by way of proviso or negative limitation.

As may be used herein, the terms ‘preferred’, ‘preferably’, ‘typical’, ‘typically’ or ‘optionally’ do not limit the scope of the invention or embodiments thereof.

As may be used herein the term ‘substantially’ (or synonyms thereof) denote with respect to the context a measure or extent or amount or degree that encompass a large part or most of a referenced entity, or an extent at least moderately or much greater or larger or more effective or more important relative to a referenced entity or with respect to the referenced subject matter.

As used herein the term ‘may’ denotes an option or an effect which is either or not included and/or used and/or implemented and/or occurs, yet the option constitutes at least a part of some embodiments of the invention or consequence thereof, without limiting the scope of the invention.

The phrase “and/or,” as used herein in the specification and in the claims, should be understood to mean “either or both” of the elements so conjoined, e.g., elements that are conjunctively present in some cases and disjunctively present in other cases. Other elements may optionally be present other than the elements specifically identified by the “and/or” clause, whether related or unrelated to those elements specifically identified unless clearly indicated to the contrary.

As used herein in the specification and in the claims, “or” should be understood to have the same meaning as “and/or” as defined above. For example, when separating items in a list, “or” or “and/or” shall be interpreted as being inclusive, e.g., the inclusion of at least one, but also including more than one, of a number or list of elements, and, optionally, additional unlisted items. In general, the term “or” as used herein shall only be interpreted as indicating exclusive alternatives (e.g. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

As used herein “a plurality” is understood to be any number greater than one. “Plurality” means “two or more”.

It should also be understood that, unless clearly indicated to the contrary, in any methods claimed herein that include more than one step or act, the order of the steps or acts of the method is not necessarily limited to the order in which the steps or acts of the method are recited.

The following description provides an overview and description of non-limiting embodiments of a planter module constructed in accordance with the present invention. While illustrative examples are described herein, these examples are not intended to be exhaustive or to limit the invention to the precise forms disclosed. Similarly, any process steps described herein, e.g., for assembling or configuring an embodiment of the present invention, may be interchangeable with other steps, or several combinations of steps, in order to achieve the benefits and advantages of the invention.

Referring now to the drawings, the modular components of the modular panel system are shown in different modular structure non-limiting embodiments.

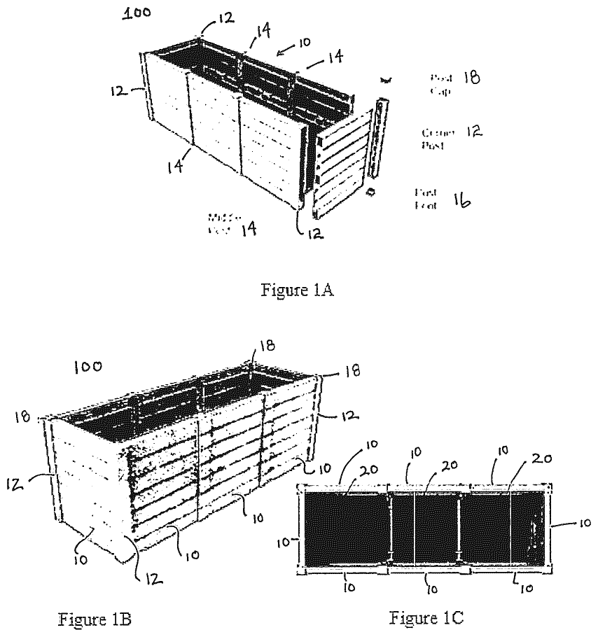

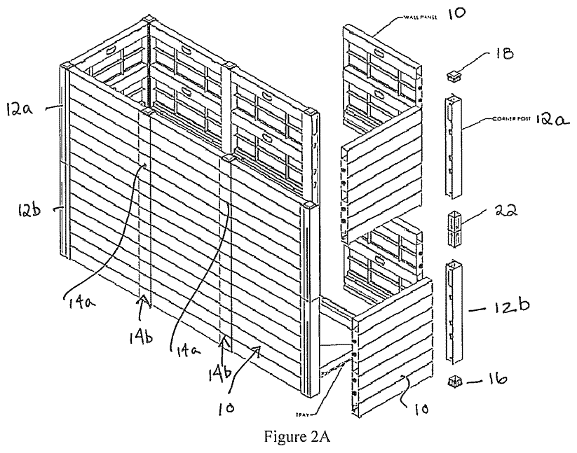

In FIG. 1A is shown a modular raised garden bed 100 that is partially unassembled to show the modular structure components in accordance with a non-limiting embodiment of the invention. The modular raised garden bed 100 in this embodiment is one level and comprises reversibly interconnected: eight modular wall panel(s) 10, four modular corner post(s) 12, four modular middle post(s) 14, eight modular post feet 16, eight modular post cap(s) 18, and three modular base tray(s) 20. FIG. 1B shows the modular raised garden bed 100 fully assembled to show the overall rectangular and seamless body design. FIG. 1C shows the three modular base trays.

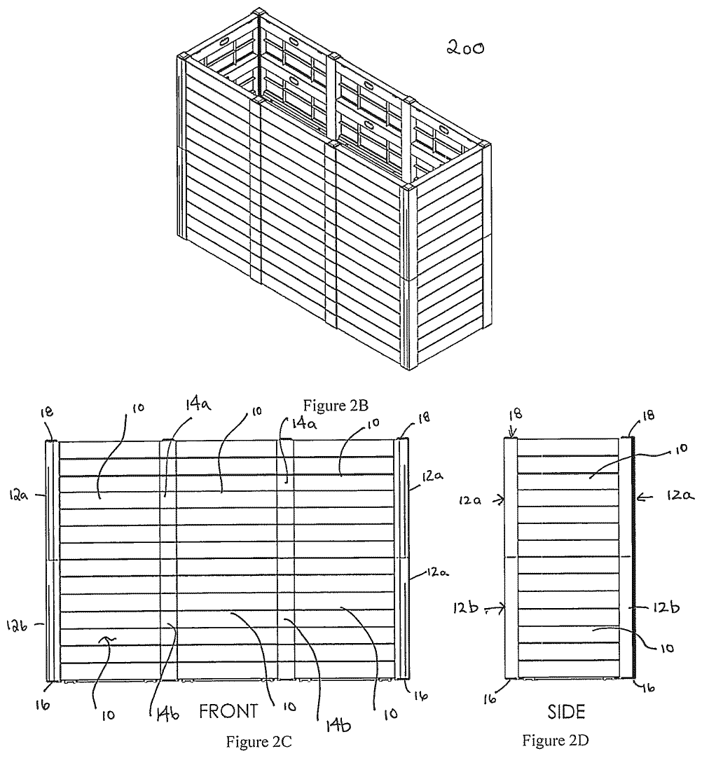

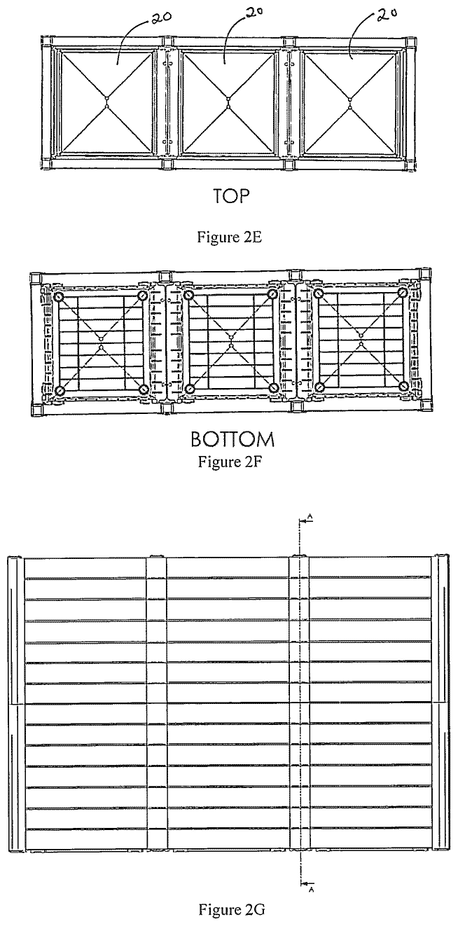

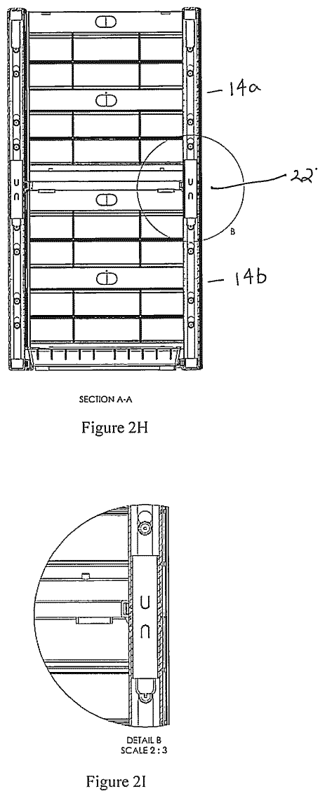

Referring to FIG. 2A is shown is shown a modular two tier raised garden bed 200 that is partially unassembled to show the modular structure components in accordance with a non-limiting embodiment of the invention. The two tier modular raised garden bed 200 comprises reversibly interconnected: sixteen modular wall panel(s) 10, eight modular corner post(s) 12, eight modular middle post(s) 14, eight modular post feet 16, eight modular post cap(s) 18, eight modular post connectors 22, and three modular base tray(s) 20. A modular post connector 22 is received the post(s) and secures/supports the upper corner post 12a with the lower corner post 12b as well is used to secure/support the upper middle post 14a with the lower middle post 14b.

FIG. 2B shows the modular raised garden bed 200 fully assembled to show the overall rectangular and seamless body design.

FIG. 2C shows the front of the modular two tier raised garden bed 200 comprising six modular wall panels 10. The overall appearance is a seamless continuous construction where any of the connection mechanisms are not visible providing a very pleasing clean esthetic. The clean seamless esthetic design is also seen at each side of the two tier raised garden bed 200 as shown in FIG. 2D.

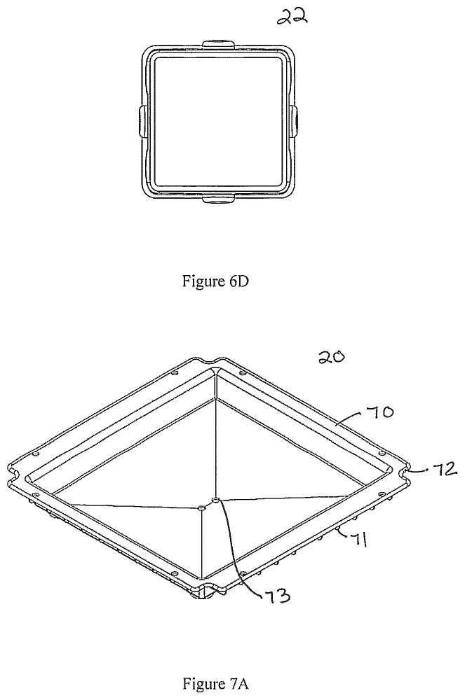

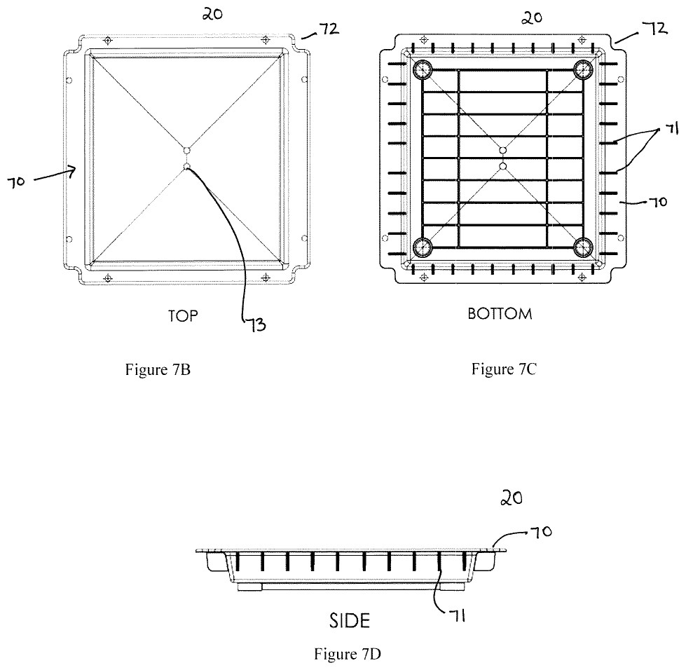

FIGS. 2E and 2F shows the three base trays 20 that seemingly form one continuous bottom support of the modular two tier raised garden bed 200. As shown in FIG. 2E the base trays are set and supported within the modular assembly and are configured for engagement with each other and the wall panels in a structurally sound manner. The modular corner posts 12, modular middle posts 14 and modular wall panels 10 are shown to form a close/tight interconnection with the base trays thus the structure 200 is absent of any gaps. FIG. 2F shows the outside bottom configuration of the raised garden bed 200 showing each of the base trays 20. These are shown in more detail in FIGS. 7A-7D.

FIG. 2H in a cross section of lines A-A of FIG. 2G that shows the connection of the two modular middle posts 14a and 14b with the modular post connector 22. As more clearly shown in FIG. 21, the modular posts 14a and 14b are configured such that they fit with the hollow supporting modular post connector 22 such that the bottom end of the top middle post 14a abutting and resting on the top end of the bottom middle post 14b. The modular post connector 22 securing/supporting 14a with 14b.

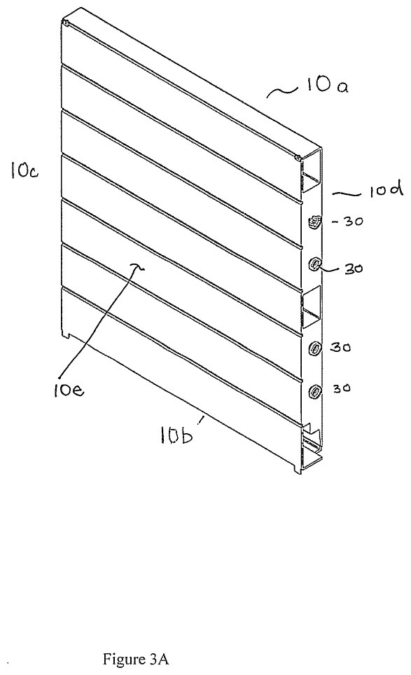

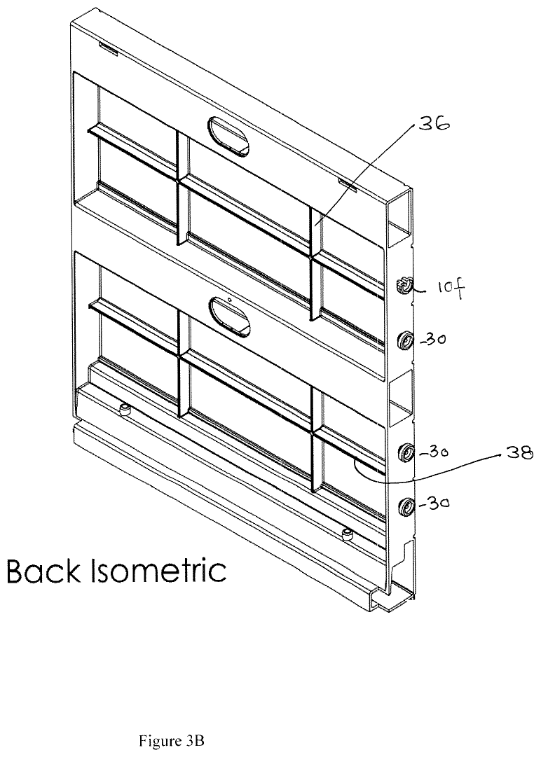

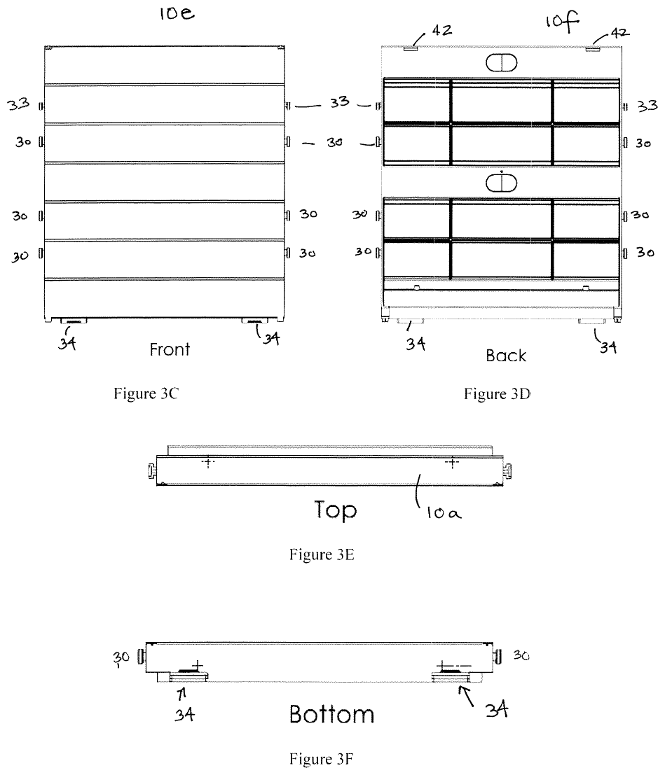

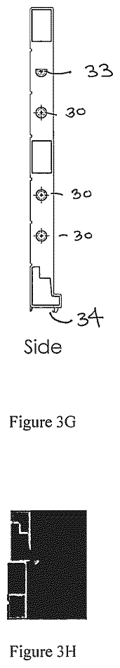

As seen in FIGS. 3A and 3C, the modular wall panel 10 has a top 10a, a bottom, 10b, a left side 10c and a right side 10d. The modular wall panel 10 has a front face 10e configured to present a lateral slat profile. It should however, be understood that the front face 10e can be configured to present any design desired profile or pattern. The modular wall panel 10 has a unitary body 12. The modular wall panel 10 has integral connection systems on the left side 10c and the right side 10d and further an integral connection system on the bottom 10b that is different from that presented on the left side 10c and right side 10d. The left side 10c is shown to have integrally formed outwardly extending pegs (or lugs) 30 that are configured to be received within keyhole slots F24 on present on the middle 14 and corner posts 12 for allowing attachment/connection. The pegs 30 allow a close secure connection along the entire sides 10c and 10d of the wall panel 10 to a middle 14 or corner post 12. The left side 10c also has an integrally formed outwardly extending receptable 33 for receiving a detent connection tab present on the middle 14 and corner posts 12 for allowing attachment/connection thereto. This type of detent connection holds the wall panel in a fixed configuration with either middle 14 or corner 12 to prevent/minimize vertical movement of the wall panel 10 relative to the connected post (12 or 14). The combination of the plurality of pegs and the detent connection provides a secure connection along several points of the structure preventing horizontal and vertical movement of the wall panel 10 with respect to the post 12, 14 to which it is connected.

FIG. 3E shows the top 10a of the wall panel 10 to be substantially flat and smooth. FIGS. 3F and 3G show the bottom 10B of the wall panel to have extending clip portions 34 that engage with, and resiliently clip within slots 42 (FIG. 3D) on the back face 10f of the wall panel 10. As seen in FIG. 3h, this secures the bottom 10B of a wall panel to the top 10a of a second wall panel in a snap fit connection to make taller structures. This arrangement is concealed from view and not seen when modular structures are made with 2 or more levels (tiers) of wall panels. The clip 26 configuration also allows for a connection to a tray 50 (FIGS. 7A-7D) that forms the bottom (a floor) of the structure.

As shown in FIG. 3B the wall panel 10 is of hollow construction as the back face 10f of the wall panel 10 has an integrally formed reinforcing framework of interconnected cooperating vertical struts 36 and horizontal struts 38 with areas of recesses. The framework functions to accommodate both tensile and compressive forces. This reinforcing framework provides better stability to the wall panel 10 without making the wall panel too bulky or heavy. This reinforcing framework is also configured in a manner to add further connectable accessories such as for example a shelf and rod system (shown in FIGS. 10A and 10B).

While the wall panel 12 is shown substantially square in shape, the wall panel 12 can be fabricated to be substantially rectangular in shape. The wall panel 12 can be fabricated of any desired dimensions (length, width, height). The wall panel 12 is shown with a slat design, however, it is understood by one skilled in the art that the wall panel can be fabricated with any decorative surface as desired. The wall panel 12 can also be fabricated to have a cut out within its front face 10 10e and left open, or alternatively provided with a door, screen or the like.

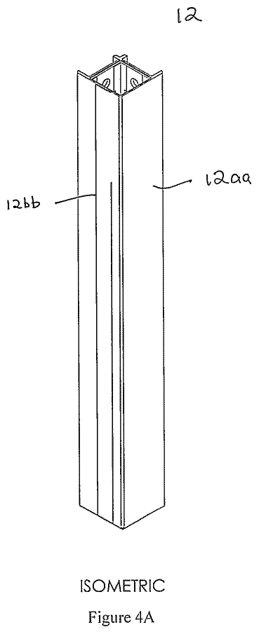

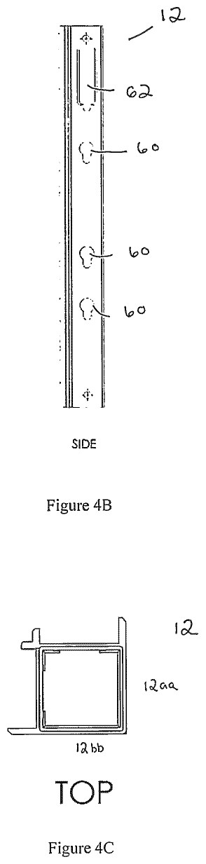

FIG. 4A shows a modular corner post 12 having two substantially flat faces 12aa, 12bb, is integrally formed, and generally hollow in construction (FIG. 4C). FIG. 4B shows one of the two connection faces 12c and 12d (12d being identical to 12c). Faces 12c and 12d each have three keyhole slots 60 for receiving each of the outwardly extending pegs 30 of the wall panel 10. Faces 12c and 12d also each have an integrally formed, resilient detent connection tab 62. The detent connection tab 62 has a downwardly extending body that ends with a rounded protrusion 64 that can be snap fit within the extending receiving receptable 32 of the wall panel. This connection mechanism ensures that the corner post is held in a fixed position, without vertical movement, in relation to the connected wall panel.

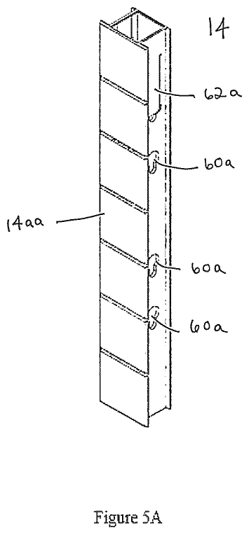

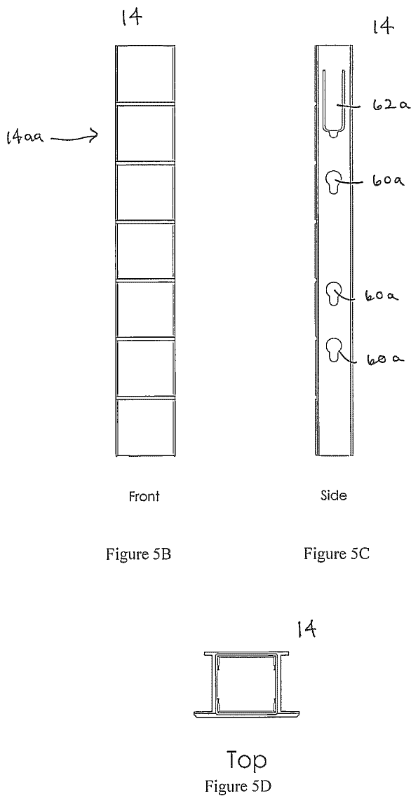

FIGS. 5A and 5B show a modular middle post 14 having a front face 14aa with a horizontal slat design, is integrally formed, and generally hollow in construction (FIG. 5D). The middle post 14 has two connection faces 14b and 14c (that are identical). Both connection faces 14b and 14c also have each have three keyhole slots 60a for receiving each of the outwardly extending pegs 30 of the wall panel 10. Faces 14b and 14c also each have an integrally formed, resilient detent connection tab 62a as described with reference to the modular corner post. This connection mechanism ensures that the middle post is held in a fixed position, without vertical movement, in relation to the connected wall panel.

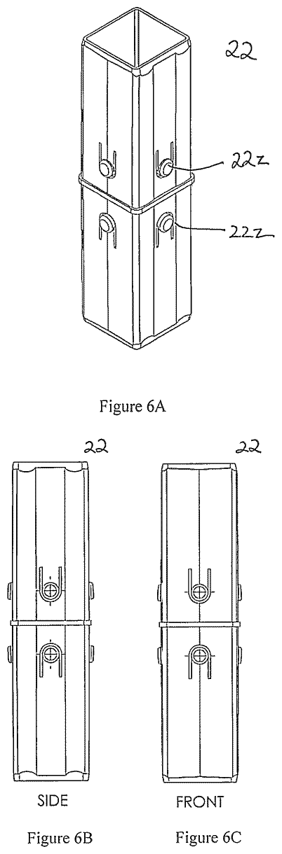

FIGS. 6A-6D show the post connecter 22 being an integrally formed substantially elongated hollow body that is received within the body of the posts 12, 14. The hollow body has resilient projections 22z to provide a more tight frictional fit when engaged/fit with the posts. These resilient projections 22z can engage with the detent connection tab or keyhole slots of the post(s) for a tighter connection.

The corner post 12, middle post 14 and the post connector 22 can be fabricated at varying lengths. A post cap 30 can be affixed by a snap fit within the top of the posts 12, 14. Further, a post foot 16 can be snap fit within the bottom of the posts 12, 14. The post cap can be of any design, size and material so long as its base can be fit securely into the top of the post 22, 22. The post foot 16 can also be of any design and size and in embodiments can include castor wheels or similar. While the connection of the wall panel 10 to a post 12, 14 is shown as a slot and corresponding peg connection, it is understood that this can vary as long as the components can be connected in a reversible manner without the use of fasteners or tools. Furthermore, while the posts are shown to have a square cross-section, this also can vary to be of varying shapes (for e.g. round). Still further, the connection can be a slidable connection and/or a rotatable connection.

FIGS. 7A-7D show a modular base tray 20 for use as a base/floor in a variety of structures that can be made in accordance with the modular panel system of the invention. With respect to FIG. 7A, the base tray 20 has an integrally formed outward projecting substantially flat ledge 70 along its entire perimeter. The corners of the perimeter are notched 72 to accommodate a corner post 12 or a middle post. The flat ledge 70 supports the bottom 10b of the wall panel. The underside of the flat ledge 70 has projections 71 extending downwardly. The bottom of the wall panel is configured to engage with the flat ledge of the base tray and clip thereto via the clipping portions 34 of the wall panel within the projection portions. This permits securing the bottom of a wall panel to the base tray.

The tray 20 is an integrally formed component and is substantially basin shaped. It has one or more holes 73 for drainage into which suitable plugs can be inserted and also or alternatively can be fabricated to have a water reservoir.

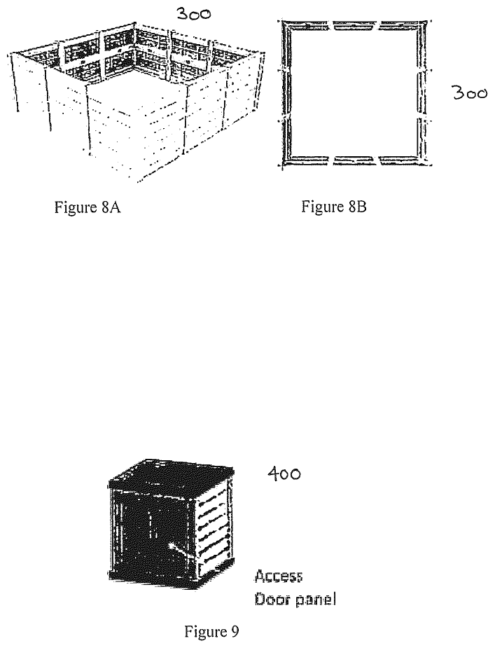

FIGS. 8A and 8B shown a further embodiment of the modular panel system of the invention showing an assembled raised garden bed structure 300 that has an open bottom configuration, that is substantially square shaped and is for example sized as 16.25″ in height, 48″ in length and 48″ in width. In this embodiment, twelve wall panels, four corner posts, eight middle posts, twelve post caps, and twelve post feet are used. Cables can optionally be used for additional strength whereby the hook cable ends can be engaged to the back (inside face) of the wall panel(s). This embodiment shown as a single level raised garden bed can be provided as a kit comprising these components and alternatively instructions for use and packaged. A second or third tier of panels can also be added. It is understood that the structure can be altered to be smaller, taller, and/or shaped differently (e.g. rectangular). It is also understood that the structure can be disassembled and reassembled as a box planter, a shed or other type of structure.

The modular panel system of the invention can utilize and assemble any number of wall panels 10 with the corresponding structural components depending on the desired structure to be made with respect to shape, width, desired height and purpose.

An assembled raised garden bed structure that is for example sized as 16.25″ in height, 48″ in length and 17″ in width. In this embodiment, eight wall panels, four corner posts, four middle posts, eight post caps, eight post feet and three trays are used. The optional cable feature may be selected from a wire eye, wire loop, swivel eye, cable hook, clevis or the like that is anchored at lengths (at the middle posts) across the garden bed structure providing additional support when the structure is in use. The embodiment shown as a raised garden bed can be provided as a kit comprising these components and alternatively instructions for use and packaged. Similar structural components can be provided as separate kits, for example, a set of 4-8 wall panels can be one kit. It is understood that the structure can be altered to be taller, that is a second row of wall panels can be connected. It is also understood that the structure can be disassembled and reassembled as a box planter, a shed or other type of structure.

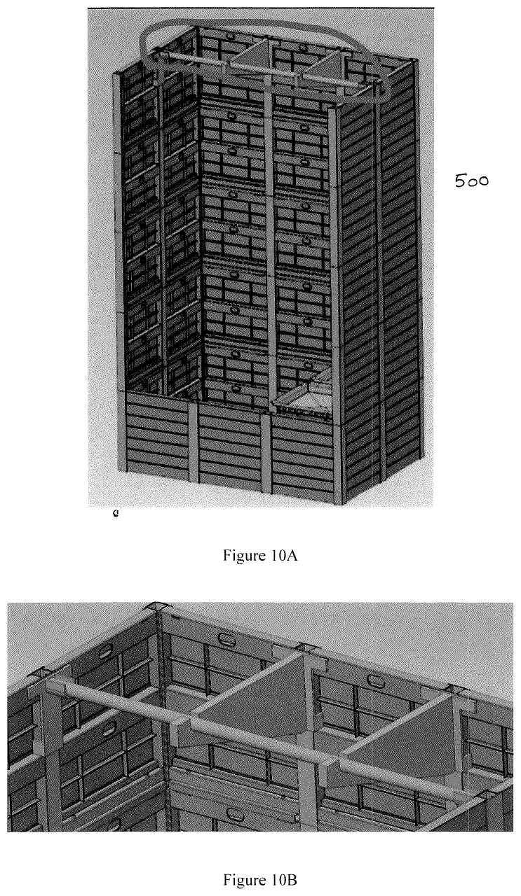

FIG. 9 is a perspective view of the modular panel system configured as a patio storage table 400 with a door access panel. A table top is attached via corner and/or middle posts. In an aspects via spikes used to stack/join the corner and joiner posts. Whether a table top, a cover, or a roof panel (for example on a shed structure), these are snap fit via a receiver cup (e.g. square like the corner posts) that the spike snaps/fits inside.

FIG. 10A shows a further embodiment of the modular panel system of the invention, configured as a storage cabinet 500 with a shelf and rod system. FIG. 10B more clearly shows the shelf and rod system.

From the foregoing it will be evident that the embodiments described provide a modular panel system which can be provided as a kit of parts which can be packaged in a compact manner and be readily transported. Further, the connection system integral to the modular panels and other structural components of the system according to the invention allow the kit to be easily and conveniently assembled to provide a robust structure.

Again, it is understood by one skilled in the art that structures made using the modular panel system of the invention can be made of any desired height, width, and shape. The thickness of the wall panels can vary.

### FEATURE ACCESSORIES

The modular panel system described herein, can further be configured to include one or more of:
1. Shelf and rod system for indoor storage;
2. Filler panels for toe kicks and additional sizing capabilities;
3. Legs/Feet for raised coffee tables, bars, hutches, stands, shelves and the like;
4. Drawer mounted slides for drawers;
5. Window inserts;
6. Locking/Handle/Door Hardware attachments;
7. Hinge attachments for doors;
8. Strut attachments for Deck boxes/Doors;
9. Access Panels;
10. Hanger and organization methods for tooling, cleaning items;
11. Laundry/Shelving tray systems;
12. Decorative close out panels for refined inside finishes;
13. Lighting/Wring/Watering Track; and
14. Roofing.

### Fabrication

The physical composition and construction of the modular structural components of the modular panel system described herein provides unique durability and expandability. In aspects, the modular structural components may be integrally formed from plastic(s) and composite composition(s) which comprise suitable characteristics of for example, hardness, durability, texture, strength, flexibility, ease of molding, and the like. For example, composite compositions comprising recycled plastics, sawdust and/or wood pulp and resins can be used that are pressed into molds to create a modular structural component. Synthetic resins such as polyethylene, in aspects high density polyethylene (HDPE) can be used to make modular structural components described herein. However, other materials are also contemplated including metals, polypropylene and polystyrene. Although high density polyethylene may be preferred, the use of low density polyethylene, linear low density polyethylene and mixtures of high density/low density polyethylene are also contemplated as is linear low density polyethylene (LLDPE).

Components may be formed by standard injection molding procedures well known in the art. Briefly, in one aspect high density polyethylene is melted, injected into a mold, allowed to cool and removed from the mold.

The material of construction may be enhanced using ultraviolet radiation inhibitors to improve durability and retention of physical characteristics such as color and surface texture as well as a strengthening filler as desired.

The structural components of the modular panel system are strong and not capable of any significant flexing. In particular, the wall panels cannot be flexed to form a curved configuration. On the contrary, the walls provide substantially rigid surfaces.

Again, the components may be made by example by injection molding methods and may or may not include any integrated parts or components using a wide range of thermoplastic polymers, resins and elastomers. They can be injected molded from compositions comprising plastic, recycled plastic, recycled crumb rubber and mixtures thereof. Briefly in one aspect, injection molded wall panels may be generally made by pouring a raw plastic composition into a hopper, then heating injecting it into a custom mold. Pressure is used to accommodate shrinkage and once the plastic molded wall panel has fully cooled, the mold is opened, and the wall panel removed. Structural components of the system of the invention can be also made incorporating techniques of over-molding and insert molding.

In aspects, the components of the invention are made from a suitable polyolefin selected from the group consisting of polyethylene, polypropylene, polybutene, polyisoprene, polypentene and mixtures thereof. In aspects the polyolefin is polyethylene or polypropylene. The polyolefin can be from a recycled source.

In other aspects the polyolefin can further comprise admixed particles of crumb rubber to form a mixture for injection molding. In aspects, the crumb rubber can comprise a synthetic rubber selected from styrene-butadiene rubber (SBR—a copolymer of styrene and butadiene), ethylene propylene diene rubber (EPDM—a terpolymer of ethylene, propylene and a diene-component), ethylene propylene rubber (EPR), butadiene rubber (BR) and mixtures thereof. Any rubber source can be of a recycled nature. When heated at temperatures of about 140° C. to about 230° C., inclusive of any specific temperature in between, the polyolefin will melt about the crumb rubber. The amount of crumb rubber to polyolefin used in the composition for injection molding a planter module is understood by one of skill in the art to range and can be up to about 25% by weight.

Up to about 10% by weight additives can be incorporated into the composition for injection molding as desired to improve and/or alter certain properties of the end product, as would be understood by a skilled person. These are selected from the group consisting of titanium dioxide, UV stabilizers, calcium carbonate, talc, flame retardants and combinations thereof. It is also understood that in embodiments of the invention, no additives are incorporated. Up to about 10% by weight colorant can be incorporated into the composition for injection molding as desired. It is also understood that in embodiments of the invention, no colorants may be incorporated.

Advantageously, the modular panel system of the invention comprises components configured for releasably but secure and stable connection with other components without requiring any fasteners or the like. Thus large modular stable structures can be assembled, disassembled and reassembled quickly and efficiently requiring no fasteners or tools. Importantly, structures can be transformed into new structures with different functions. This provides for versatility. The system incorporate a high efficiency reversible fit between structural components. The fit assembly is highly stable for superior stability and safety.

Assembled structures have a high aesthetic presence.

Only a few of the several embodiments of modular structures comprising the modular panel system have been illustrated herein. It is understood that a myriad of combinations for the modular structural components can evolve and each possible combination is up to an individual, and of said possible combinations does not deviate from the spirit and scope of this invention.

Non-limiting embodiments may comprise:

1. A modular structure comprising:
at least one wall panel,
at least one corner post,
at least one middle post,
optional post cap,
optional post foot,
optional post connector, and
optional base tray,
wherein the at least one wall panel comprises an integral body, the body comprising a first connection means at each side for reversibly securing to the at least corner post and/or to the at least one corresponding post, and a second connection means located at the bottom for reversibly securing to a top of a second wall panel or the optional base tray.
   2. A modular panel system comprising structural components comprising one or more of a wall panel, corner post, middle post, post cap, post foot, post connector, and base tray, said structural components reversibly connectable to form a structure selected from a planter, raised garden bed, storage shed, bar, bar cart, storage chest, table and container hose reel,
wherein the at least one wall panel comprises an integral body, the body comprising a first connection means for reversibly securing to the corner post and/or to the middle post, and a second connection means for reversibly securing to a top of a second wall panel and/or the optional base tray.
   3. A kit for making a modular structure comprising: at least one wall panel, corner post, middle post, post cap, post foot, post connector, base tray, optional decorative element(s), optional cable(s) and combinations thereof; and optional instructions for assembly,
wherein the at least one wall panel comprises an integral body comprising a first connection means for reversibly securing to the corner post and/or to the middle post, and a second connection means for reversibly securing to a top of a second wall panel and/or the base tray.
   4. A wall panel, the wall panel having a vertical axis and a horizontal axis, the wall panel being substantially rectangular shaped and comprising two types of connection means allowing for both horizontal and vertical reversible connection to post member(s) and or a base member.
   5. A wall panel, the wall panel having a vertical axis and a horizontal axis, the wall panel being substantially square shaped and comprising two types of connection means allowing for both horizontal and vertical reversible connection to a post member(s), and/or a base member.
   6. A wall panel comprising an integral body, the body comprising a first connection means at each side for reversibly securing to a corresponding post; and a second connection means located at the bottom for reversibly securing to a top of a second wall panel or base tray.
   7. The wall panel of any one of embodiments 4 to 6, wherein said wall panel is made by injection molding, double injection molding, over-molding, gas-assisted molding or microcellular injection molding.
   8. The modular structure, the modular panel system or the wall panel of any one of embodiments 1 to 7, comprising:
plastic, wood and/or metal, optionally one or more of the plastic, wood and metal is from a recycled source; or
polyethylene, polypropylene, polystyrene polybutene, polyisoprene, polypentene and mixtures thereof; and/or
crumb rubber comprising a synthetic rubber selected from styrene-butadiene rubber, ethylene propylene diene rubber, ethylene propylene rubber (EPR), butadiene rubber (BR) and mixtures thereof; and/or
an ultraviolet radiation inhibitor; and/or
up to about 10% by weight additives selected from the group consisting of titanium dioxide, UV stabilizers, calcium carbonate, talc, flame retardants and combinations thereof; and/or
up to about 10% by weight colorant.
   9. The modular structure according to embodiment 9, wherein the structure is a planter.

While the invention has been described with respect to certain specific embodiments, it will be appreciated that many modifications and changes may be made by those skilled in the art without departing from the spirit of the invention. It is intended, therefore, by the appended claims to cover all such modifications and changes as fall within the true spirit and scope of the invention as defined by the claims.

1.-8. (canceled)

9. A modular panel structure comprising:
a plurality of wall panels for reversible connection;
a plurality of corner post(s);
a plurality of middle post(s);
optionally one or more base tray(s);
wherein each wall panel of the plurality of wall panels comprises a first connection means for reversibly securing each side of the wall panel to a corner post and/or middle post, and a second connection means located at the bottom for reversibly securing to a top of a wall panel or to the optional base tray;
wherein the first connection means comprises (i) means to prevent/minimize vertical movement and (ii) means to increase horizontal stability with respect to the wall panel and the corner post/and or middle post;
wherein assembly and connection of the plurality of wall panels, the plurality of corner post(s), the plurality of middle post(s), and the optionally one or more base tray(s) forms a structure arrangement suitable for indoor or outdoor use.

10. The modular panel structure of claim 9, wherein the modular wall panel comprises a top, a bottom, a left side, a right side, a front face and a back face, wherein the left side and the right side comprise the first connection means, and optionally wherein the wall panel is substantially rectangular shaped or substantially square shaped.

11. The modular panel structure of claim 10, wherein the (i) means to prevent/minimize vertical movement comprises one or more integrally formed outwardly extending pegs, each extending peg for mounting within a corresponding keyhole slot located on a side of the corner post and middle post, the pegs slide down within the keyhole slot to securely hold the wall panel to the corner post and/or middle post.

12. The modular panel structure of claim 9, wherein the (ii) means to increase horizontal stability comprises an integrally formed outwardly extending receptable for receiving a detent connection tab present on the corner post and/or middle post.

13. The modular panel structure of claim 9, wherein the second connection means comprises extending clip portions for engaging and resiliently clipping within slots on the wall panel.

14. The modular panel structure of claim 9, comprising the at least one base tray that is secured to the bottom of a wall panel.

15. The modular panel structure of claim 14, wherein the at least one base tray is substantially basin shaped and comprises one or more holes for drainage and for receiving drainage plugs.

16. The modular panel structure of claim 14, wherein the base tray comprises an integrally formed outward projecting substantially flat ledge along its entire perimeter to support the bottom of the wall panel thereon and clip thereto via clipping portions of the wall panel, the flat ledge comprising downwardly projecting projections.

17. The modular panel structure of claim 16, wherein the bottom of the wall panel is configured to engage with the flat ledge of the base tray and clip thereto via the extending clip portions of the wall panel for securing the bottom of the wall panel to the base tray.

18. The modular panel structure of claim 9 wherein the wall panel is of hollow construction, the wall panel having a back face with an integrally formed reinforcing framework of interconnected cooperating vertical struts and horizontal struts with areas of recesses for accommodating both tensile and compressive forces.

19. The modular panel structure of claim 9, further comprising a plurality of post connecter(s) for vertically connecting two middle posts or two corner posts to make a two tier structure arrangement.

20. The modular panel structure of claim 19, wherein the post connector is a substantially elongated hollow body that is received within the body of the posts, and wherein the hollow body has resilient projections to provide a tight frictional fit when engaged/fit with the posts, the projections for engaging with the detent connection tab or keyhole slots of the post(s).

21. The modular panel structure of claim 9, wherein the structure arrangement is a planter; raised garden bed; storage shed, garbage bin, recycling bin; storage container; salt storage box; deck box; composter; garbage bin; bars bar cart; storage chest; table; vegetable box; shelving; closet storage/organization system; armoire/hutch; playhouse; garage cabinet and wall system; shoe/boot shelf/cabinet; table; panel deck flooring system; gazebo; outdoor kitchen cabinetry; and container hose reel.

22. The modular panel structure of claim 9, wherein the structure arrangement comprises two or more tiers of assembled and connected wall panels and posts.

23. The modular panel structure of claim 19, wherein the wall panel(s), corner post(s), middle post(s), post connector(s), and base tray(s) are each fabricated as integral components.

24. The modular panel structure of claim 19, wherein one or more of the wall panel(s), corner post(s), middle post(s), post connector(s), and base tray(s) are made by injection molding, double injection molding, over-molding, gas-assisted molding or microcellular injection molding.

25. The modular panel structure of claim 9, wherein the wall panel(s), corner post(s), middle post(s), post connector(s) and base tray(s) are fabricated from compositions comprising:
thermoplastic polymers, resins, elastomers, plastics, recycled plastics (composites), recycled crumb rubber and any mixtures thereof.

26. The modular panel structure of claim 9, wherein the wall panel(s), corner post(s), middle post(s), post connector(s), and base tray(s) are fabricated from compositions comprising a polyolefin selected from the group consisting of polyethylene, polypropylene, polybutene, polyisoprene, polypentene and mixtures thereof.

27. The modular panel structure of claim 9, wherein:
a formed structure arrangement can be disassembled and reassembled into a disparate structure; and/or
assembly to form a structure arrangement does not require tools and/or fasteners.

28. The modular panel structure of claim 9, wherein the wall panel comprises:
plastic, wood and/or metal, optionally one or more of the plastic, wood and metal is from a recycled source; or
polyethylene, polypropylene, polystyrene polybutene, polyisoprene, polypentene and mixtures thereof; and/or
crumb rubber comprising a synthetic rubber selected from styrene-butadiene rubber, ethylene propylene diene rubber, ethylene propylene rubber (EPR), butadiene rubber (BR) and mixtures thereof; and/or
an ultraviolet radiation inhibitor; and/or
up to about 10% by weight additives selected from the group consisting of titanium dioxide, UV stabilizers, calcium carbonate, talc, flame retardants and combinations thereof;
and/or up to about 10% by weight colorant.

29. A kit for making the modular structure of claim 9, comprising: at least one wall panel, at least one corner post, at least one middle post, optionally at least one post cap, optionally at least one post foot, at least one post connector, optionally at least one base tray, optional decorative element(s), optional cable(s) and combinations thereof; and optional instructions for assembly.
